(19) United States
(12) Patent Application Publication
(10) Pub. No.: US 2005/0171987 A1
(43) Pub. Date: Aug. 4, 2005

(54) Scalable folded low-complexity pipeline, method of pipelining and multiple-input, multiple-output receiver employing the same

(75) Inventors: Manish Goel, Plano, TX (US); David L. Milliner, Dallas, TX (US); Srinath Hosur, Plano, TX (US); Muhammad Z. Ikram, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/919,873

(22) Filed: Aug. 17, 2004

Related U.S. Application Data
(60) Provisional application No. 60/540,652, filed on Jan. 30, 2004.

(51) Int. Cl. G06F 7/38

(52) U.S. Cl. 708/233

(57) ABSTRACT

The present invention provides a folded low-complexity (FLC) pipeline. In one embodiment, the FLC pipeline includes a dot product unit chain configured to employ only addition and multiplication operations to compute intermediate numerators and denominators from a received signal matrix, a channel gain matrix and a noise matrix. Additionally, FLC pipeline also includes a divider stage configured to terminate the dot product unit chain by computing an unscaled quotient and a scale factor from ultimate ones of the intermediate numerators and denominators.

### CROSS-REFERENCE TO PROVISIONAL APPLICATION

This application claims the benefit of U.S. Provisional Application No. 60/540652 entitled “System and Method for a Multiple-Input Multiple-Output (MIMO) Linear Minimum Mean Squared Error (LMMSE) Employing a Division-Free Modular Approach” to Manish Goel, et al., filed on Jan. 30, 2004, which is incorporated herein by reference in its entirety.

### TECHNICAL FIELD OF THE INVENTION

The present invention is directed, in general, to a communication system and, more specifically, to a folded low-complexity (FLC) pipeline, a method of FLC pipelining and a multiple-input, multiple-output communication system receiver employing the pipeline or the method.

### BACKGROUND OF THE INVENTION

Multiple-input multiple output (MIMO) communication systems have been shown to provide improvements in capacity and reliability over single-input single-output (SISO) communication systems. MIMO communication systems commonly employ a block structure wherein a MIMO transmitter, actually a collection of single-dimension transmitters, sends a vector of symbol information. This symbol vector may represent one or more coded or uncoded SISO data symbols. The transmitted signal propagates through the channel and is received and processed by a MIMO receiver. The MIMO receiver can obtain multiple receive signals corresponding to each transmitted symbol. The performance of the entire communication system hinges on the ability of the receiver to find reliable estimates of the symbol vector that was transmitted.

For such MIMO communication systems, a receive signal may be written in the form:

$${y}_{k} = {\sum }_{n} {H}_{n} {s}_{k - n} + v ,$$

where Hₙ is an Mᵣ by Mₜ matrix of common gains, sₖ is the Mₜ-dimensional symbol vector transmitted at time k and ν is an Mᵣ-dimensional symbol vector of additive noise.

If the noise ν were not present, and Hₙ were invertible, an estimate of sₖ may be achieved by inverting Hₙ. However, the presence of noise increases the difficulty of estimating sₖ. An optimal solution in the sense of minimizing the probability of error has been shown to be the maximum likelihood (ML) decoder. The ML decoder attempts to find the symbol vector sₖ sent at burst k by using the symbol vector that maximizes a conditional probability density function of sₖ based on the receive signals y₁-yₖ. However, in real-time communication systems, use of the ML decoder is overly computationally complex. Another approach is to use a linear minimum mean squared error (LMMSE) approach, which is less computationally complex. However, this approach still requires division and standard matrix inversion.

Accordingly, what is needed in the art is a way to employ an LMMSE approach in estimating the symbol vector sₖ that is less computationally complex.

### SUMMARY OF THE INVENTION

To address the above-discussed deficiencies of the prior art, the present invention provides a folded low-complexity (FLC) pipeline. In one embodiment, the FLC pipeline includes a dot product unit chain configured to employ only addition and multiplication operations to compute intermediate numerators and denominators from a received signal matrix, a channel gain matrix and a noise matrix. Additionally, the FLC pipeline also includes a divider stage configured to terminate the dot product unit chain by computing an unscaled quotient and a scale factor from ultimate ones of the intermediate numerators and denominators.

In another aspect, the present invention provides a method of folded low-complexity (FLC) pipelining. The method includes initially computing intermediate numerators and denominators from a received signal matrix, a channel gain matrix and a noise matrix employing only addition and multiplication. The method also includes subsequently computing an unscaled quotient and a scale factor from ultimate ones of the intermediate numerators and denominators.

The present invention also provides, in yet another aspect, a multiple-input, multiple-output (MIMO) communication system receiver employing M receive antennas, wherein M is at least two. The MIMO receiver employs M receive channels that are coupled to the M receive antennas, respectively, and a folded low-complexity (FLC) pipeline, that is coupled to the M receive channels. The FLC pipeline has a dot product unit chain that employs only addition and multiplication operations to compute intermediate numerators and denominators from a received signal matrix, a channel gain matrix and a noise matrix. The FLC pipeline also has a divider stage that terminates the dot product unit chain by computing an unscaled quotient and a scale factor from ultimate ones of the intermediate numerators and denominators.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an N×M MIMO communication system that is constructed in accordance with the principles of the present invention;

FIG. 2 illustrates a simplified block diagram of an embodiment of a FLC pipeline employable with a 3×3 MIMO communication system and constructed in accordance with the principles of the present invention;

FIG. 3 illustrates a structural diagram of an embodiment of one of the modules of the FLC pipeline shown in FIG. 2 and constructed in accordance with the principles of the present invention;

FIG. 4 illustrates a detailed block diagram of an embodiment of a FLC pipeline employable with a 3×3 MIMO communication system and constructed in accordance with the principles of the present invention; and

FIG. 5 illustrates a flow diagram of an embodiment of a method of FLC pipelining carried out in accordance with the principles of the present invention.

### DETAILED DESCRIPTION

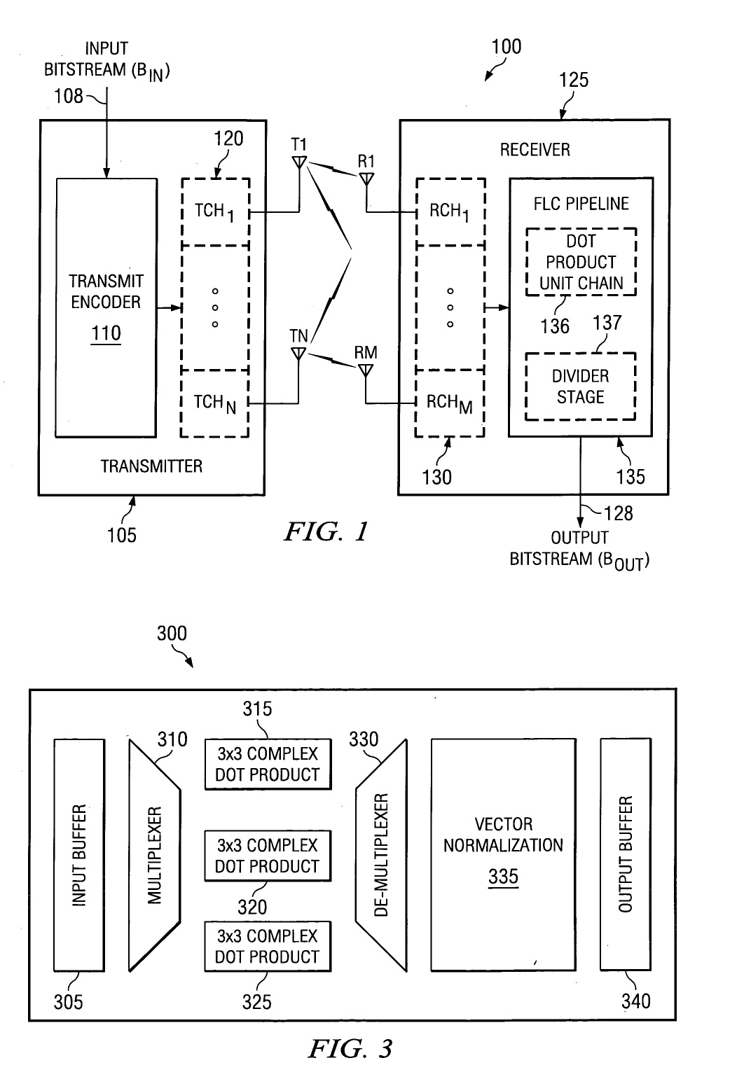

Referring initially to FIG. 1, illustrated is a system diagram of an embodiment of an N×M MIMO communication system, generally designated 100, that is constructed in accordance with the principles of the present invention. The N×M MIMO communication system 100 includes a MIMO transmitter 105 and a MIMO receiver 125. The MIMO transmitter 105 includes a transmit input 108 having an input bitstream Bᵢₙ, a transmit encoder 110 and a transmit system 120 having N transmit channels TCH₁-TCH_{N} that are coupled to N transmit antennas T1-TN, respectively. The MIMO receiver 125 includes a receive system 130 having M receive antennas R1-RM that are respectively coupled to M receive channels RCH₁-RCH_{M}, and a folded low-complexity (FLC) pipeline 135 having a receive output 128 that provides an output bitstream Bₒᵤₜ.

The transmit encoder 110 encodes the input bitstream Bᵢₙ into vector symbols for presentation to the transmit channels TCH₁-TCH_{N}. The transmit channels TCH₁-TCH_{N} include the frequency tuning, modulation and power amplification circuitry required to condition and transmit the transmit substreams. Similarly, the receive channels RCH₁-RCH_{M} contain the required capture, detection and recovery circuitry to allow processing of receive substreams into a symbol configuration that may be employed by the FLC pipeline 135. The FLC pipeline 135 processes the receive substreams into the output bitstream Bₒᵤₜ that is representative of the input bitstream Bᵢₙ. The MIMO receiver 125 has an estimate of the matrix of complex gains available to it.

The FLC pipeline 135 includes a dot product unit chain 136 that employs only addition and multiplication operations to compute intermediate numerators and denominators from a received signal matrix, a channel gain matrix and a noise matrix. The FLC pipeline 135 also includes a divider stage 137 that terminates the dot product unit chain by computing an unscaled quotient and a scale factor from ultimate ones of the intermediate numerators and denominators.

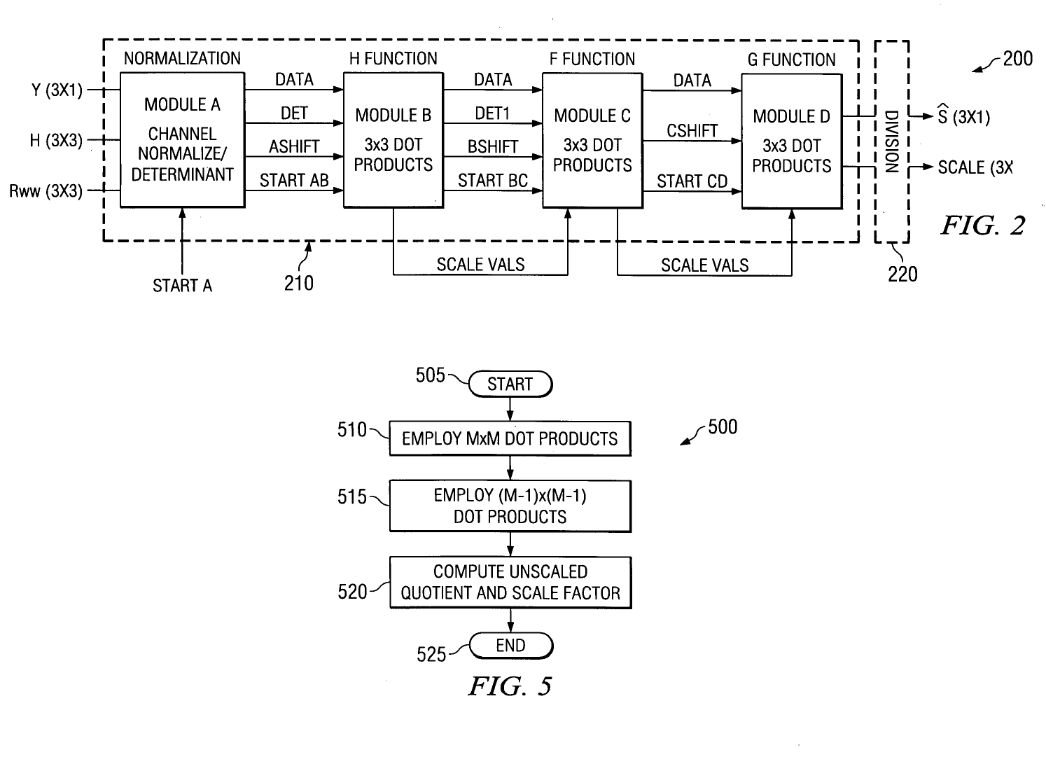

The dot product unit chain 136 employs a beginning M×M dot product unit for computing intermediate numerators and denominators and at least one additional (M−1)×(M−1) dot product unit that computes the ultimate ones of the intermediate numerators and denominators. The quantity M, of course, corresponds to the N×M MIMO communication system 100, wherein M≧N. The beginning M×M dot product unit computes intermediate numerators and denominators employing a product of the channel gain matrix and an adjoint of the noise matrix. The additional (M−1)×(M−1) dot product unit computes the ultimate ones of the intermediate numerators and denominators employing a remainder based on a determinate of the noise matrix. Similarly, the divider stage 137 computes the scale factor from a remainder based on the determinate of the noise matrix. An exemplary embodiment corresponding to a 3×3 MIMO communication system, wherein the dot product unit chain 136 employs three dot product units, will be discussed with respect to FIGS. 2, 3 and 4.

Turning now to FIG. 2, illustrated is a simplified block diagram of an embodiment of a FLC pipeline, generally designated 200, employable with a 3×3 MIMO communication system and constructed in accordance with the principles of the present invention. The FLC pipeline 200 includes a dot product unit chain 210 and a divider stage 220. The dot product unit chain 210 includes first, second, third and fourth modules A, B, C, D, as shown. Inputs to the first module A include a received signal matrix y, a channel gain matrix H and a noise matrix R_{WW}. The divider stage 220 provides outputs of a transmit signal estimate ŝ and a scale factor scale.

The first module A is employed for channel normalization and computation of the determinant for the noise variance estimation matrix. The second, third and fourth modules B, C, D are complex dot product modules. When a preceding module has completed its computation, it asserts a START signal indicating that its output data is ready to be conveyed to the succeeding module to begin additional computation by that module.

Each of these modules is folded on itself, which significantly reduces the amount of device area required to implement the module. This folding allows modification of an otherwise parallel design into a smaller device area that computes serially at a faster clocking speed. In the illustrated embodiment for module B, the three-antenna receiver requires twelve 3×3 complex dot products wherein three dot products are conjugates. This reduces the requirement to nine 3×3 complex dot products, which may be accommodated by three 3×3 complex dot products that employ a tripling of the clock speed.

Turning now to FIG. 3, illustrated is an implementation diagram of an embodiment of a module of the FLC pipeline shown in FIG. 2, generally designated 300, and constructed in accordance with the principles of the present invention. In the illustrated embodiment, the FLC pipeline module 300 is representative of module B of FIG. 2 and includes an input buffer 305, a multiplexer 310, first, second and third 3×3 complex dot product units 315, 320, 325, (collectively designated the dot product module 315-325) a de-multiplexer 330, a vector normalization unit 335 and an output buffer 340.

The input buffer 305 holds input data that is subsequently selected by the multiplexer 310. Data path operations are performed employing the first, second and third 3×3 complex dot product units 315, 320, 325 for computation as appropriate for each set of multiplexed data. After computation, the multiplexed data is de-multiplexed employing the de-multiplexer 330 into its proper output location. The data path is then normalized and buffered by the vector normalization unit 335 and the output buffer 340 for transfer to the next module.

Vector normalization is used to reduce the precision necessary at the output of the dot product module 315-325. This computation may be optional, but is typically important in reducing the overall device area, since a cascade of such multipliers will necessarily provide an increase in precision without the use of this normalization. However, only the precision of the multipliers is affected and not the total number of multipliers necessary.

The FLC pipeline 300 provides a folding that effectively employs a reduced number of real multipliers while providing an LMMSE algorithm. For example, the FLC pipeline 300 may employ a total of 78 real multipliers wherein the first module A employs 10, the second module B employs 29, the third module C employs 26 and the fourth module D employs 14 real multipliers, respectively. In contrast, an unfolded 3×3 LMMSE pipeline may employ a total of 212 real multipliers wherein the first module A would employ 22, the second module B would employ 83, the third module C would employ 65 and the fourth module D would employ 42 real multipliers, respectively.

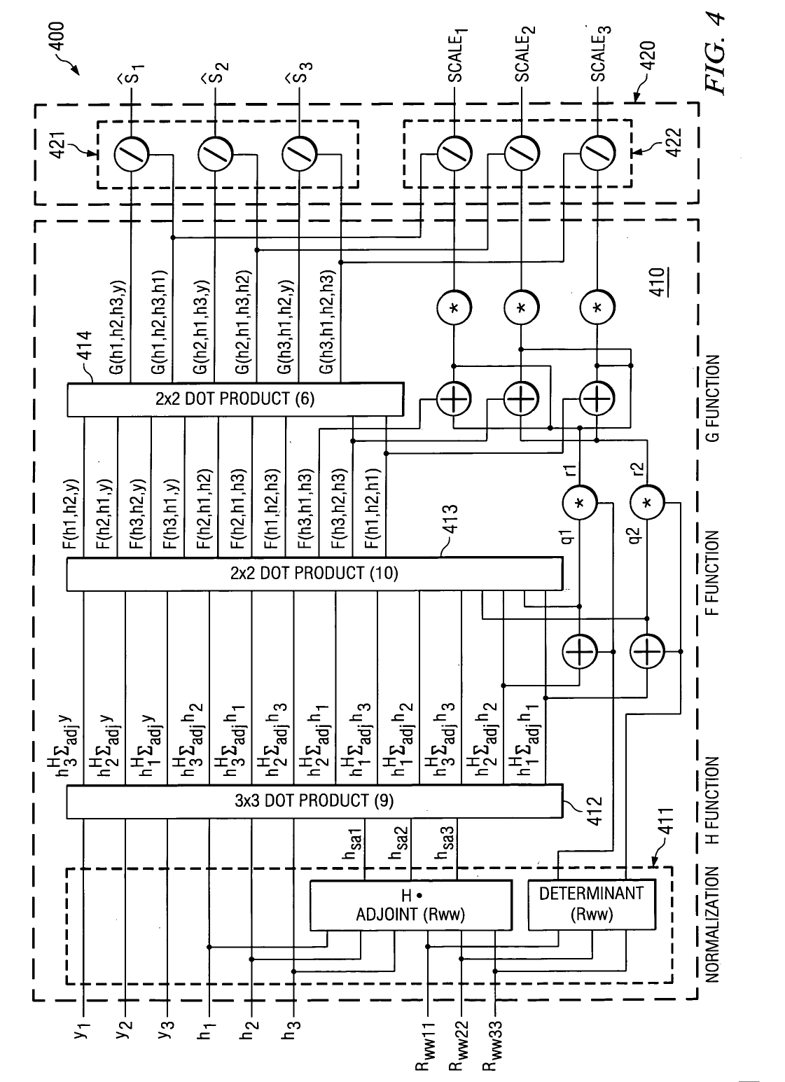

Turning now to FIG. 4, illustrated is a detailed block diagram of an embodiment of an FLC pipeline, generally designated 400, employable with a 3×3 MIMO communication system and constructed in accordance with the principles of the present invention. The FLC pipeline 400 includes a dot product unit chain 410 and a divider stage 420. The dot product unit chain 410 includes a normalization stage 411, a beginning 3×3 dot product unit 412 and first and second 2×2 dot product units 413, 414. The divider stage 420 includes an unscaled quotient unit 421 and a scaling factor unit 422.

The normalization stage 411 employs channel gain matrix components h₁, h₂, h₃ of the channel gain matrix H and noise variance estimation matrix diagonals R_{WW11}, R_{WW22}, R_{WW33} of a covariance R_{WW} of a noise vector w to provide adjunct channel gain products hₛₐ₁, hₛₐ₂, hₛₐ₃ and a determinant of the covariance R_{WW}, as shown. The beginning 3×3 dot product unit 412 employs received signal matrix components y₁, y₂, y₃ of a received signal matrix y, the channel gain matrix components h₁, h₂, h₃ and the adjunct channel gain products hₛₐ₁, hₛₐ₂, hₛₐ₃ to compute first intermediate numerators and denominators using only addition and multiplication. Additionally, the first 2×2 dot product unit 413 employs these first intermediate numerators and denominators to provide second intermediate numerators and denominators. Then the second 2×2 dot product unit 414 employs these second intermediate numerators to provide ultimate ones of the intermediate numerators and denominators. The divider stage 425 employs these ultimate ones of the intermediate numerators and denominators to provide a transmit signal estimate ŝᵢ[n] from the unscaled quotient unit 421 and a scale factor scaleᵢ[n] from the scaling factor unit 422.

In general, the transmit signal estimate ŝᵢ[n] may be expressed as:

$${\hat{s}}_{i} [ n ] = \frac{{{h}_{i}^{H} ( {h}_{j} {h}_{j}^{H} + {R}_{WW} )}^{- 1} y [ n ]}{{{h}_{i}^{H} ( {h}_{j} {h}_{j}^{H} + {R}_{WW} )}^{- 1} {h}_{i}} . \qquad ( 1 )$$

In the illustrated embodiment, the FLC pipeline 400 provides the ability to accommodate the 3×3 MIMO data paths using the LMMSE equations shown below while employing only one division and avoiding standard matrix inversion.

$$\begin{matrix}{\hat{s}}_{1} [ n ] = \frac{{{h}_{1}^{H} ( {h}_{2} {h}_{2}^{H} + {h}_{3} {h}_{3}^{H} + Σ )}^{- 1} y [ n ]}{{{h}_{1}^{H} ( {h}_{2} {h}_{2}^{H} + {h}_{3} {h}_{3}^{H} + Σ )}^{- 1} {h}_{1}} & ( 1 a ) \\ {\hat{s}}_{2} [ n ] = \frac{{{h}_{2}^{H} ( {h}_{1} {h}_{1}^{H} + {h}_{3} {h}_{3}^{H} + Σ )}^{- 1} y [ n ]}{{{h}_{2}^{H} ( {h}_{1} {h}_{1}^{H} + {h}_{3} {h}_{3}^{H} + Σ )}^{- 1} {h}_{2}} & ( 1 b ) \\ {\hat{s}}_{3} [ n ] = \frac{{{h}_{3}^{H} ( {h}_{1} {h}_{1}^{H} + {h}_{2} {h}_{2}^{H} + Σ )}^{- 1} y [ n ]}{{{h}_{3}^{H} ( {h}_{1} {h}_{1}^{H} + {h}_{2} {h}_{2}^{H} + Σ )}^{- 1} {h}_{3}} & ( 1 c )\end{matrix}$$

A key feature of this pipeline is that it provides a substantially division-free approach wherein a final required division may be performed with a slicer that is separate from the MIMO datapath. The manipulation to arrive at the FLC pipeline 200 structure described above, although not intuitive, is straightforward and will be described below. Specifically, the computation of ŝᵢ[n] will be addressed realizing that ŝ₂[n] and ŝ₃[n] may be computed in a similar manner.

Initially, the similarity of the numerator and denominator of ŝ₁[n] may be advantageously employed by grouping them into a function denoted as G in equation (2) below.

$${\hat{s}}_{1} [ n ] = \frac{{{h}_{1}^{H} ( {h}_{2} {h}_{2}^{H} + {h}_{3} {h}_{3}^{H} + Σ )}^{- 1} y [ n ]}{{{h}_{1}^{H} ( {h}_{2} {h}_{2}^{H} + {h}_{3} {h}_{3}^{H} + Σ )}^{- 1} {h}_{1}} = \frac{G ( {h}_{1} , {h}_{2} , {h}_{3} , y )}{G ( {h}_{1} , {h}_{2} , {h}_{3} , {h}_{1} )} \qquad ( 2 )$$

It is desired that the function G be modular and division-free since it will necessarily be computed six times in the 3×3 MIMO series of FLC equations. In order to determine the form of the function G, the term (h₂h₂^{H}+h₃h₃^{H}+Σ)⁻¹ is first examined, which can be rewritten using the Matrix Inversion Lemma as:

$${( {h}_{2} {h}_{2}^{H} + {h}_{3} {h}_{3}^{H} + Σ )}^{- 1} = {( {h}_{3} {h}_{3}^{H} + Σ )}^{- 1} - \frac{{( {h}_{3} {h}_{3}^{H} + Σ )}^{- 1} {h}_{2} {{h}_{2}^{H} ( {h}_{3} {h}_{3}^{H} + Σ )}^{- 1}}{1 + {{h}_{2}^{H} ( {h}_{3} {h}_{3}^{H} + Σ )}^{- 1} {h}_{2}} \qquad ( 3 )$$

Then, the entire numerator h₁^{H}(h₂h₂^{H}+h₃h₃^{H}+Σ)⁻¹y can be rewritten using Equation (3) as:

$$G ( {h}_{1} , {h}_{2} , {h}_{3} , y ) = \{ {{h}_{1}^{H} ( {h}_{3} {h}_{3}^{H} + Σ )}^{- 1} y \} - \frac{\{ {{h}_{1}^{H} ( {h}_{3} {h}_{3}^{H} + Σ )}^{- 1} {h}_{2} \} \{ {{h}_{2}^{H} ( {h}_{3} {h}_{3}^{H} + Σ )}^{- 1} y \}}{1 + \{ {{h}_{2}^{H} ( {h}_{3} {h}_{3}^{H} + Σ )}^{- 1} {h}_{2} \}} \qquad ( 4 )$$

Now, simplifying the first term h₁^{H}(h₃h₃^{H}+Σ)⁻¹y, and recognizing that the other terms will follow the same simplification procedure, the Matrix Inversion Lemma may again be employed to rewrite equation (4) as:

$${{h}_{1}^{H} ( {h}_{3} {h}_{3}^{H} + Σ )}^{- 1} y = {h}_{1}^{H} ( {\sum }^{- 1} - \frac{{\sum }^{- 1} {h}_{3} {h}_{3}^{H} {\sum }^{- 1}}{1 + {h}_{3}^{H} {\sum }^{- 1} {h}_{3}} ) y . \qquad ( 5 )$$

Since,

$${\sum }^{- 1} = \frac{{\sum }_{adj}}{{σ}_{1}^{2} {σ}_{2}^{2} {σ}_{3}^{2}} = \frac{{\sum }_{adj}}{det ( Σ )} ,$$

the denominator of equation (5) may be written as det(Σ)+h₃^{H} Σ_{adj}h₃ after multiplying through by det(Σ). This allows equation (5) to be written as:

$${{h}_{1}^{H} ( {h}_{3} {h}_{3}^{H} + Σ )}^{- 1} y = \frac{( det ( Σ ) + {h}_{3}^{H} {\sum }_{adj} {h}_{3} ) {h}_{1}^{H} {\sum }_{adj} y - ( {h}_{1}^{H} {\sum }_{adj} {h}_{3} ) {h}_{3}^{H} {\sum }_{adj} y}{( det ( Σ ) + {h}_{3}^{H} {\sum }_{adj} {h}_{3} ) det ( Σ )} . \qquad ( 6 a )$$

Without division, this becomes:
h₁^{H}(h₃h₃^{H}+Σ)⁻¹y)det(Σ)+h₃^{H}Σ_{adj}h₃)det(Σ)=(det(Σ)+h₃^{H}Σ_{adj}h₃)h₁^{H}Σ_{adj}y−(h₁^{H}Σ_{adj}h₃)h₃^{H}Σ_{adj}y (6b)
Referring to the term (det(Σ)+h₃^{H}Σ_{adj}h₃) as Q1(h3) and the term Q1(h3)det(Σ) as R1(h3), the function Q employs only addition and the function R employs only multiplication.

This allows the equation (6b) to be rewritten as:

$$\begin{matrix}{{h}_{1}^{H} ( {h}_{3} {h}_{3}^{H} + Σ )}^{- 1} y = \frac{Q 1 ( {h}_{3} ) {h}_{1}^{H} {\sum }_{adj} y - ( {h}_{1}^{H} {\sum }_{adj} {h}_{3} ) {h}_{3}^{H} {\sum }_{adj} y}{R 1 ( {h}_{3} )} \\ = \frac{F ( {h}_{1} , {h}_{3} , y )}{R 1 ( {h}_{3} )} .\end{matrix} \qquad ( 7 )$$

Similarly other F functions used to compute G(h₁,h₂,h₃,y) may be defined as follows:
F(h₁,h₃,h₂)=Q1(h₃)h₁^{H}Σ_{adj}h₂−(h₁^{H}Σ_{adj}h₃)(h₃^{H}Σ_{adj}h₂) (8a)
F(h₂,h₃,y)=Q1(h₃)h₂^{H}Σ_{adj}y−(h₂^{H}Σ_{adj}h₃)(h₃^{H}Σ_{adj}y) (8b)
F(h₂,h₃,h₂)=Q1(h₃)h₂^{H}Σ_{adj}h₂−(h₂^{H}Σ_{adj}h₃)(h₃^{H}Σ_{adj}h₂) (8c)
The equations shown above are 2×2 dot products whose terms are just answers of 3×3 dot products. The division-free term referred to as the F function is simply a 2×2 dot product and is represented by the first 2×2 dot product unit 212. These F functions may be employed to compute the G function.

Having defined the F, Q, and R functions, the G function in equation (4) may now be written for the numerator of ŝ₁[n] as:

$$G ( {h}_{1} , {h}_{2} , {h}_{3} , y ) = \frac{F ( {h}_{1} , {h}_{3} , y )}{R 1 ( {h}_{3} )} - \frac{F ( {h}_{1} , {h}_{3} , {h}_{2} ) F ( {h}_{2} , {h}_{3} , y )}{( 1 + \frac{F ( {h}_{2} , {h}_{3} , {h}_{2} )}{R 1 ( {h}_{3} )} ) R 1 {( {h}_{3} )}^{2}} \qquad ( 9 )$$

In turn, equation (9) may be rewritten as:
G(h₁,h₂,h₃,y)R2(h1)=F(h₁,h₃,y)[R1(h₃)+F(h₂,h₃,h₂)]−F(h₁h₃,h₂)F(h₂,h₃,y), (10)
where the scale factor R2(h₁) is defined as:
R2(h₁)=Q₂(h₁)R₁(h₃)=Q₂(h₁)[Q1(h₃)det(Σ)]. (11)
By ignoring the scale factor for G in the left hand side, equation (10) may be rewritten as:
G(h₁,h₂,h₃,y)=F(h₁,h₃,y)Q2(h₁)−F(h₁,h₃,h₂)F(h₂,h₃,y), (12)
where Q2(h₁)=[R1(h₃)+F(h₂,h₃,h₂)]. It may be noted that the forms of F and G are the same in that they are both 2×2 Dot Products. The G function is represented by the second 2×2 dot product unit 213.

This derivation accomplishes the desired result of a modular algorithmic structure composed of G, F, Q, and R functions, which is division-free. The only divisions (which are unavoidable) have been pushed all the way to the divider stage 220 employing the slicer. Therefore, to compute ŝ₁[n], the equation (13) below is the only division in the entire data flow.

$${\hat{s}}_{1} [ n ] = \frac{G ( {h}_{1} , {h}_{2} , {h}_{3} , y )}{G ( {h}_{1} , {h}_{2} , {h}_{3} , {h}_{1} )} \qquad ( 13 )$$

Continually pushing division forward in the computation has the impact of requiring a scale factor. The scale factor for ŝ₁[n] is simply the denominator divided by all of the terms that have been brought up to the numerator. In a reduced form this term is:

$${scale}_{1} [ n ] = \frac{G ( {h}_{1} , {h}_{2} , {h}_{3} , {h}_{1} )}{R 2 ( {h}_{1} )} \qquad ( 14 )$$

Again, this division can be handled by the slicer. Due to the modularity exhibited above, ŝ₂[n] and ŝ₃[n] may also be calculated using the structure of equations (13) and (14) where:

$$\begin{matrix}{\hat{s}}_{2} [ n ] = \frac{G ( {h}_{2} , {h}_{1} , {h}_{3} , y )}{G ( {h}_{2} , {h}_{1} , {h}_{3} , {h}_{2} )} , & ( 15 a ) \\ {\hat{s}}_{3} [ n ] = \frac{G ( {h}_{3} , {h}_{1} , {h}_{2} , y )}{G ( {h}_{3} , {h}_{1} , {h}_{2} , {h}_{3} )} , & ( 15 b ) \\ {scale}_{2} [ n ] = \frac{G ( {h}_{2} , {h}_{1} , {h}_{3} , {h}_{2} )}{R 2 ( {h}_{2} )} , & ( 15 c ) \\ {scale}_{3} [ n ] = \frac{G ( {h}_{3} , {h}_{1} , {h}_{2} , {h}_{3} )}{R 2 ( {h}_{3} )} . & ( 15 d )\end{matrix}$$

It may be noted that the 3×3 matrix Hsa is the multiplication of the adjoint of the noise (sigma) matrix and the H matrix, which turns out to be just nine complex multiplications. There are actually twelve 3×3 dot products that need to be computed in the beginning 3×3 dot product unit 412, but three of these answers are conjugates of already computed dot products. The nine computations and three conjugates are shown below in corresponding mathematical representations 16a through 16l of the outputs of the beginning 3×3 dot product unit 412.
h₁^{H}Σ_{adj}h₁ (16a)
h₁^{H}Σ_{adj}h₂ (16b)
h₁^{H}Σ_{adj}h₁ (16c)
h₂^{H}Σ_{adj}h₁ (16d)
h₂^{H}Σ_{adj}h₂ (16e)
h₂^{H}Σ_{adj}h₃ (16f)
h₃^{H}Σ_{adj}h₁ (16g)
h₃^{H}Σ_{adj}h₂ (16h)
h₃^{H}Σ_{adj}h₃ (16i)
h₁^{H}Σ_{adj}y (16j)
h₂^{H}Σ_{adj}y (16k)
h₃^{H}Σ_{adj}y (16l)
It may be noted that there are other equally suitable configurations for selecting the computations to perform, which may employ alternative terms and conjugates having the same complexity in terms of dot products and conjugates.

The F function then takes the results of these 3×3 dot products and computes the following 2×2 dot products in the first 2×2 dot product unit 413. There are ten 2×2 dot products and two conjugate computations as shown in equations (17a)-(17j) below. These ten 2×2 dot products are:
F(h1,h2,y)=q2*h₁^{H}Σ_{adj}y−h₁^{H}Σ_{adj}h₂*h₂^{H}Σ_{adj}y (17a)
F(h1,h2,h1)=q2*h₁^{H}Σ_{adj}h₁−h₁^{H}Σ_{adj}h₂*h₂^{H}Σ_{adj}h₁ (17a)
F(h2,h1,y)=q1*h₂^{H}Σ_{adj}y−h₂^{H}Σ_{adj}h₁*h₁^{H}Σ_{adj}y (17a)
F(h2,h1,h2)=q1*h₂^{H}Σ_{adj}h₂−h₂^{H}Σ_{adj}h₁*h₁^{H}Σ_{adj}h₂ (17b)
F(h3,h2,h3)=q2*h₃^{H}Σ_{adj}h₃−h₃^{H}Σ_{adj}h₂*h₂^{H}Σ_{adj}h₃ (17c)
F(h1,h2,h3)=q2*h₁^{H}Σ_{adj}h₃−h₁^{H}Σ_{adj}h₂*h₂^{H}Σ_{adj}h₃ (17d)
F(h3,h2,y)=q2*h₃^{H}Σ_{adj}y−h₃^{H}Σ_{adj}h₂*h₂^{H}Σ_{adj}y (17e)
F(h2,h1,h3)=q1*h₂^{H}Σ_{adj}h₃−h₂^{H}Σ_{adj}h₁*h₁^{H}Σ_{adj}h₃ (17f)
F(h3,h1,y)=q1*h₃^{H}Σ_{adj}y−h₃^{H}Σ_{adj}h₁*h₁^{H}Σ_{adj}y (17g)
F(h3,h1,h3)=q1*h₃^{H}Σ_{adj}h₃−h₃^{H}Σ_{adj}h₁*h₁^{H}Σ_{adj}h₃ (17h)
The two conjugate computations may be expressed as:
F(h3,h2,h1)=conj(F(h1,h2,h3)) (17i)
F(h3,h1,h2)=conj(F(h2,h1,h3)) (17j)
It may also be noted that there are alternative ways to compute the above equations while maintaining the same level of overall complexity.

Finally, the G function takes the output values of the F function from the second 2×2 dot product unit 414 and computes the numerator and denominator of the final answers as show in equations (18a)-(18f) below.
num1=F(h1,h3,y)*[r2+F(h3,h2,h3)]−F(h1,h2,y)*F(h3,h2,y)=G(h1,h2,h3,y) (18a)
denom1=F(h1,h2,h2)*[r2+F(h3,h2,h3)]−F(h1,h2,h3)*F(h3,h2,h1)=G(h1,h2,h3,h1) (18b)
num2=F(h2,h13,y)*[r1+F(h3,h1,h3)]−F(h2,h1,h3)*F(h3,h1,y)=G(h2,h1,h3,y) (18c)
denom2=F(h2,h1,h2)*[r1+F(h3,h1,h3)]−F(h2,h1,h3)*F(h3,h1,h2)=G(h2,h1,h3,h1) (18d)
num3=F(h3,h2,h3)*[r2+F(h1,h2,h1)]−F(h3,h2,h1)*F(h1,h1,y)=G(h3,h1,h2,y) (18e)
denom3=F(h3,h2,h3)*[r2+F(h1,h2,h1)]−F(h3,h2,h1)*F(h1,h2,h3)=G(h3,h1,h2,h3) (18f)
Of course, one skilled in the art may extend the 3×3 embodiment discussed with respect to FIG. 4 to other values of M that are greater than one.

Turning now to FIG. 5, illustrated is a flow diagram of an embodiment of a method of FLC pipelining, generally designated 500, carried out in accordance with the principles of the present invention. The method 500 starts in a step 505 with an intent to provide a FLC solution for transmit symbol estimates associated with an N×M MIMO Communication system. In a step 510, M×M dot products associated with a received signal matrix, a channel gain matrix and a noise matrix are employed to initially compute intermediate numerators and denominators.

These numerators and denominators are then employed by at least one (M−1)×(M−1) set of dot products to subsequently compute ultimate ones of the intermediate numerators and denominators, in a step 515. The steps 515 and 520 employ only addition and multiplication. Then, in a step 520, an unscaled quotient and a scale factor associated with the transmit symbol estimates are computed. The method 500 ends in a step 525.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing an FLC pipeline, a method of FLC pipelining and an N×M MIMO communication system receiver employing the pipeline or the method have been presented. Advantages include employing only dot products and basic addition and multiplication in the initial stages of the pipeline thereby pushing any required division and scaling to the termination of the calculations. This substantially division-free solution maintains a higher degree of precision, uses less silicon area and is generally computationally faster than approaches requiring normal divisions and matrix inversions. The matrix inversion lemma is employed to find linear solutions employing MIMO communication systems, and recursive use of the matrix inversion lemma may be employed to accommodate a variable number of M receive antennas. Required division may be accommodated by a slicer.

Although the embodiments of the FLC pipeline and the method of FLC pipelining presented have been discussed with respect to a MIMO communications system, one skilled in the pertinent art will understand that they may also be generally directed toward other suitable applications wherein a matrix inversion is employed. One of these alternative applications includes a condition wherein a desired signal is present along with undesired interferers that provide interference to the desired signal. These interferers may be thought of as column terms that arise from a given matrix and contribute in an undesirable fashion. Then, interference suppression may be accommodated by applying the principles of the present invention.

Although the present invention has been described in detail, those skilled in the art should understand that they can make various changes, substitutions and alterations herein without departing from the spirit and scope of the invention in its broadest form.

1. A folded low-complexity (FLC) pipeline, comprising:
a dot product unit chain configured to employ only addition and multiplication operations to compute intermediate numerators and denominators from a received signal matrix, a channel gain matrix and a noise matrix; and
a divider stage configured to terminate said dot product unit chain by computing an unscaled quotient and a scale factor from ultimate ones of said intermediate numerators and denominators.

2. The pipeline as recited in claim 1 wherein said dot product unit chain is configured to begin with an M×M dot product unit corresponding to an N×M MIMO communication system.

3. The pipeline as recited in claim 1 wherein said dot product unit chain is configured to begin with a dot product unit that computes said intermediate numerators and denominators from a product of said channel gain matrix and an adjoint of said noise matrix.

4. The pipeline as recited in claim 1 wherein said dot product unit chain includes at least one dot product unit that further computes said ultimate ones from a remainder based on a determinate of said noise matrix.

5. The pipeline as recited in claim 1 wherein said dot product unit chain includes at least one (M−1)×(M−1) dot product unit, corresponding to an N×M MIMO communication system, that computes said ultimate ones.

6. The pipeline as recited in claim 1 wherein said divider stage is configured to compute said scale factor from a remainder based on a determinate of said noise matrix.

7. The pipeline as recited in claim 1 wherein said dot product unit chain has three dot product units and corresponds to a 3×3 MIMO communication system.

8. A method of folded low-complexity (FLC) pipelining, comprising:
initially computing intermediate numerators and denominators from a received signal matrix, a channel gain matrix and a noise matrix employing only addition and multiplication operations; and
subsequently computing an unscaled quotient and a scale factor from ultimate ones of said intermediate numerators and denominators.

9. The method as recited in claim 8 wherein said initially computing begins with M×M dot products corresponding to an N×M MIMO communication system.

10. The method as recited in claim 8 wherein said initially computing said intermediate numerators and denominators employs a product of said channel gain matrix and an adjoint of said noise matrix.

11. The method as recited in claim 8 wherein said initially computing includes further computing said ultimate ones from a remainder based on a determinate of said noise matrix.

12. The method as recited in claim 8 wherein said initially computing includes at least one set of(M−1)×(M−1) dot products, corresponding to an N×M MIMO communication system, that computes said ultimate ones.

13. The method as recited in claim 8 wherein said scale factor is computed from a remainder based on a determinate of said noise matrix.

14. The method as recited in claim 8 wherein said initial computing has three sets of dot products and corresponds to a 3×3 MIMO communication system.

15. A multiple-input, multiple-output (MIMO) receiver employing M receive antennas, wherein M is at least two, comprising:
M receive channels that are coupled to said M receive antennas, respectively;
a folded low-complexity (FLC) pipeline, that is coupled to said M receive channels, including:
a dot product unit chain that employs only addition and multiplication operations to compute intermediate numerators and denominators from a received signal matrix, a channel gain matrix and a noise matrix, and
a divider stage that terminates said dot product unit chain by computing an unscaled quotient and a scale factor from ultimate ones of said intermediate numerators and denominators.

16. The receiver as recited in claim 15 wherein said dot product unit chain begins with an M×M dot product unit.

17. The receiver as recited in claim 15 wherein said dot product unit chain begins with a dot product unit that computes said intermediate numerators and denominators from a product of said channel gain matrix and an adjoint of said noise matrix.

18. The receiver as recited in claim 15 wherein said dot product unit chain includes at least one dot product unit that further computes said ultimate ones from a remainder based on a determinate of said noise matrix.

19. The receiver as recited in claim 15 wherein said dot product unit chain includes at least one (M−1)×(M−1) dot product unit that computes said ultimate ones.

20. The receiver as recited in claim 15 wherein said divider stage computes said scale factor from a remainder based on a determinate of said noise matrix.

21. The receiver as recited in claim 15 wherein said dot product unit chain has three dot product units and corresponds to a 3×3 MIMO communication system.
